(19) United States
(12) Patent Application Publication
(10) Pub. No.: US 2016/0255993 A1
(43) Pub. Date: Sep. 8, 2016

(54) COOKING VESSEL WITH PROTECTIVE RIM

(71) Applicant: LES PROMOTIONS ATLANTIQUES INC./ATLANTIC PROMOTIONS INC., Longueuil (CA)

(72) Inventors: Zhihui FENG, Guangzhou (CN); Junbin ZHANG, Shatin (HK)

(21) Appl. No.: 14/641,262

(22) Filed: Mar. 6, 2015

(51) Int. Cl. A47J 36/02; A47J 27/00

(52) U.S. Cl. CPC A47J 36/025; A47J 27/002

(57) ABSTRACT

The present invention relates to a cooking device, and more particularly to a cooking vessel with a protective rim. A cooking vessel is provided comprising a container portion and a protective rim component. The container portion has an interior side and an edge delimiting the container portion. The interior side comprises a non-stick cooking surface. A protective rim component is mounted along the edge of the container portion, for shielding the edge, in order to prevent disintegration of the non-stick property of the cooking surface and/or the warping of the cooking vessel.

### FIELD OF THE INVENTION

The present invention relates to a cooking utensil, and more particularly to a cooking vessel with a protective rim.

### BACKGROUND OF THE INVENTION

Known in the art are pans and pots or baking dishes which have a non-stick coating to prevent food from sticking to the pan, pot or dish while the food is heated.

Traditionally, the rim of the pan or pot is considered a weak area of the pan. During use, cooking utensils can scrape the edge and disintegrates or chip the coating on this surface. Moreover, the top portion of the sidewall of the frying pan contains sharp angles and is submitted to high thermal stress. Those combined factors can make the frying pan subject to warping.

Known to the Applicant are U.S. Pat. No. 3,143,241 (HOWELL); U.S. Pat. No. 3,909,591 (ULAM); U.S. Pat. No. 3,919,763 (ULAM); U.S. Pat. No. 3,984,024 (FAUVEL); U.S. Pat. No. 4,541,411 (WOOLF); U.S. Pat. No. 4,828,134 (FERLANTI); U.S. Pat. No. 5,497,696 (COUDURIER et al.); U.S. Pat. No. 5,628,426 (DOYLE et al.); U.S. Pat. No. 7,378,623 B2 (TARENGA); U.S. Pat. No. 8,851,319 B2 (BERRUX et al.); and U.S. Pat. No. 8,939,313 B2 (CHENG), United States patent applications Nos. US 2006/0289486 A1 (CHENG); US 2007/0000915 A1 (CHENG); US 2010/0108690 A1 (GROLL); US 2011/0073602 A1 (MUSIL et al.); US 2013/0161334 A1 (LIU); US 2014/0305948 A1 (GANTILLON et al.); US 2014/0326734 A1 (LE BRIS et al.); US 2014/0361020 A1 (CHENG); and US 2015/0001226 A1 (GROLL), French patent application No. FR 2739998 (SHIBATA et al.), and International applications Nos. WO 99/56950 (GROLL) and WO 03/045208 A1 (FRAISSE et al.).

Hence, in light of the aforementioned, there is a need for an improved system which, by virtue of its design and components, would be able to overcome some of the above-discussed prior art concerns.

### SUMMARY OF THE INVENTION

The object of the present invention is to provide a device which, by virtue of its design and components, satisfies some of the above-mentioned needs and is thus an improvement over other related cooking vessels known in the prior art.

In accordance with the present invention, the above mentioned object is achieved, as will be easily understood, by a cooking vessel such as the one briefly described herein and such as the one exemplified in the accompanying drawings.

According to an aspect of the present invention, there is provided a cooking vessel comprising: a container portion having an interior side and an edge delimiting the container portion, said interior side comprising a non-stick cooking surface; and a protective rim component mounted along the edge of the container portion, in order to shield the edge of the container portion.

According to another aspect, there is provided a method of manufacturing a cooking vessel comprising: providing a container portion having an interior side and an edge delimiting the container portion; treating said interior side for producing a non-stick cooking surface; and mounting a protective rim component along the edge of the container portion, in order to shield the edge of the container portion.

The objects, advantages and features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIG. 1 is a perspective view of a cooking vessel, according to an embodiment of the present.

FIG. 2 is an enlarged view showing a portion of the cooking vessel of FIG. 1.

FIG. 3 is another enlarged view showing a portion of the cooking vessel of FIG. 1.

FIG. 4 is a top view of the cooking vessel shown in FIG. 1.

FIG. 5 is a cross-sectional view of the cooking vessel shown in FIG. 4, taken along lines 5-5.

FIG. 5A is an enlarged view of a portion of the cooking vessel shown in FIG. 5.

### DETAILED DESCRIPTION OF PREFERRED EMBODIMENTS

In the following description, the same numerical references refer to similar elements. The embodiments, geometrical configurations, materials mentioned and/or dimensions shown in the figures or described in the present description are preferred embodiments only, given for exemplification purposes only.

In the context of the present invention, the expressions “cooking vessel”, “pot”, “pan”, “frying pan”, and any other equivalent expression and/or compound words thereof known in the art will be used interchangeably.

Moreover, although the preferred embodiment of the present invention as illustrated in the accompanying drawings comprises components such as a handle, a non-stick surface, etc., and although the preferred embodiment of the cooking vessel and corresponding parts thereof consists of certain geometrical configurations and are made of particular materials as explained and illustrated herein, not all of these components, geometries and materials are essential to the invention and thus should not be taken in their restrictive sense, i.e. should not be taken as to limit the scope of the present invention. It is to be understood, as also apparent to a person skilled in the art, that other suitable components and cooperations thereinbetween, as well as other suitable geometrical configurations may be used for the cooking vessel according to the present invention, as will be briefly explained herein and as can be easily inferred herefrom, by a person skilled in the art, without departing from the scope of the invention.

Broadly described, the cooking vessel according to the present invention, as exemplified in the accompanying drawings, is a cooking vessel having a non-stick interior surface with a protective rim component mounted along an edge of the cooking vessel in order to protect the non-stick interior surface along the edge.

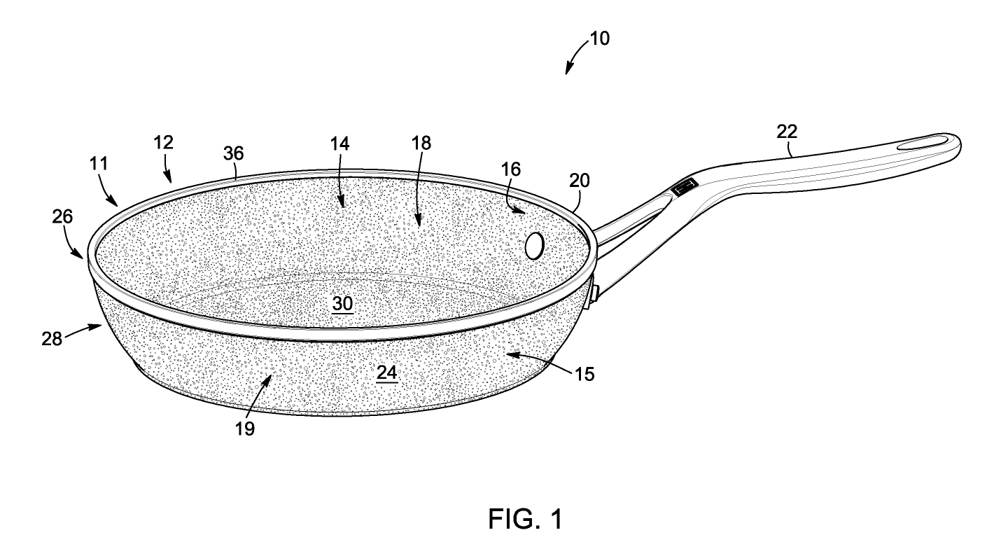

Referring to FIG. 1, there is shown a cooking vessel 10, namely a pan 11, in accordance with an embodiment. The pan 11 comprises a container portion 12 having an interior side 14 and an edge 16 delimiting the container portion 12. The interior side 14 comprises a non-stick cooking surface 18. The pan 11 further comprises a protective rim component 20 mounted along the edge 16 of the container portion 12, in order to shield the edge 16 of the container portion 12.

According to an embodiment, the container portion 12 of the pan 11 is made primarily out of aluminium. The aluminium has been surface treated with a metal pellet treatment where metal pellets are shot at high speed against the surface to form dimples across the treated surface which provides a durable non-stick surface. The pan is further coated with a non-stick coating. The non-stick interior cooking surface extends substantially along the interior side 14 of the container portion 12. The rim component 20 surrounding the pan edge 16 is made out of stainless steel. The protective rim component 20 thus has a composition of greater resistance or hardness than a composition of the container portion 12. In addition, the protective rim component 20 has a composition of greater resistance than the non-stick coating.

The protective rim component 20 advantageously prevents both the disintegration of the non-stick property of the cooking surface and the warping of the pan, thus leading to a more durable and better performing pan. Indeed, the protective rim component 20 shields the edge 16 of the container portion 12 from scratching of the non-stick surface and/or deformation at the edge during use, for example due to impacting the edge 16 with utensils or the like.

In accordance with alternative embodiments, the container portion may be made of cast iron, aluminum alloy, stainless steel-aluminum, stainless steel, copper, other suitable composite materials, and/or the like.

In addition, the protective rim component may be made of steel, cast iron, aluminum, aluminum alloy, stainless steel-aluminum, copper, and/or any other material to suitably shield the edge of the container portion from scratching of the non-stick surface and/or deformation at the edge. The protective rim component may further comprise chrome plating, nickel plating and/or any other suitable plating, depending on embodiments of the invention.

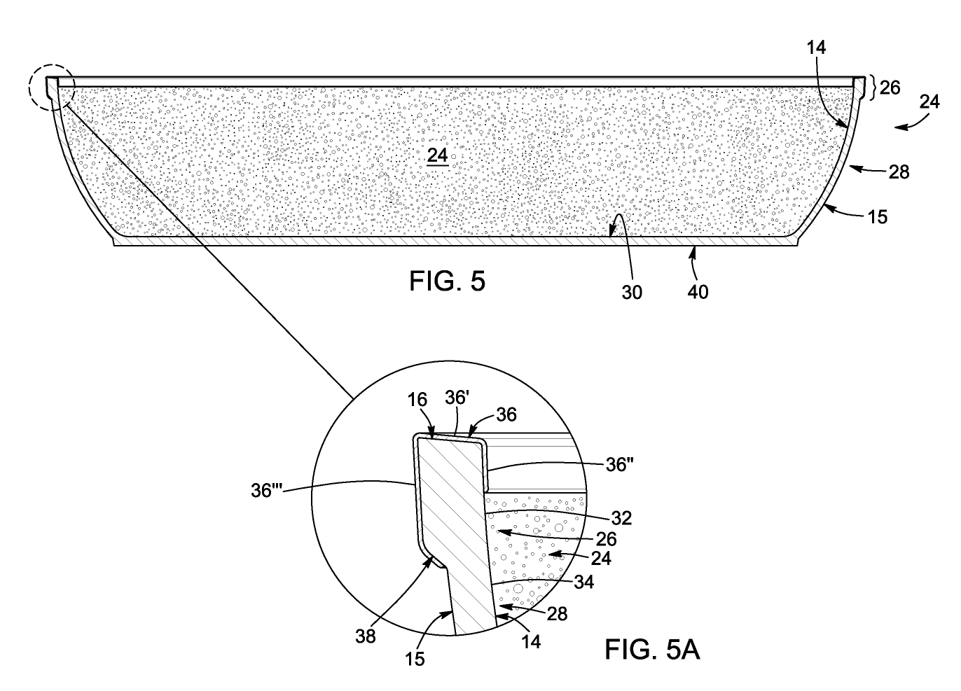

The cooking vessel 10 typically has a diameter ranging from 12 cm to 60 cm, with a height of about 25 cm or less. A stainless steel handle 22 extends from the container portion 12. The container portion further comprises an undersurface 40 (see FIG. 5) for contacting a heating element, the undersurface 40 comprising a peripheral ring having been machined from the container portion for protecting said undersurface 40.

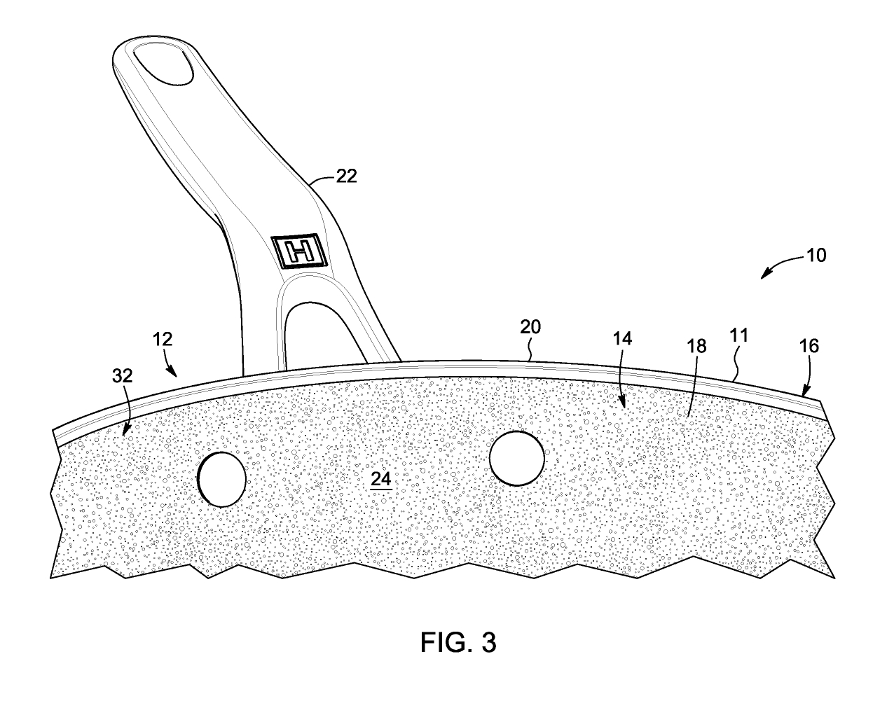

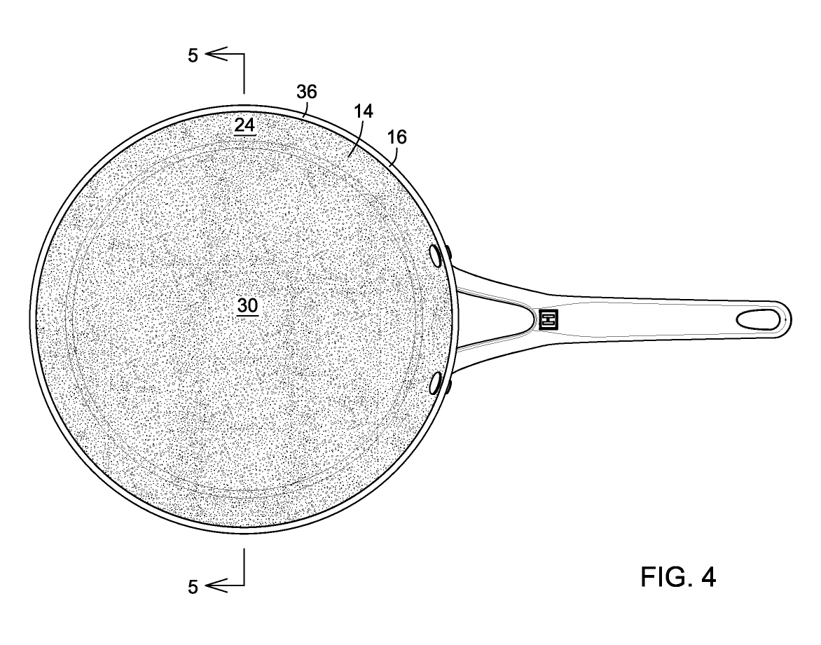

As can be seen in FIGS. 1 to 4, the container portion 12 is substantially circular and the protective rim component 20 is substantially ring-shaped and extends along the entire edge 16 of the container portion 12. It is to be understood that in accordance with alternate embodiments, the protective rim component may cover a substantial portion of the edge or may cover the edge partially. Moreover, a plurality of protective rim components may be mounted on the edge.

Reference back to FIGS. 1 to 4, the container portion comprises a wall 24 (or side wall) extending from the edge 16, the wall 24 comprising a rim portion 26 extending along said edge 16 of the container portion 12 and a main portion 28 extending from the rim portion 26. The container portion 12 comprises a bottom wall 30 from which the side wall 24 extends. The container portion 12 further comprises an exterior side 15 opposite the interior side 14.

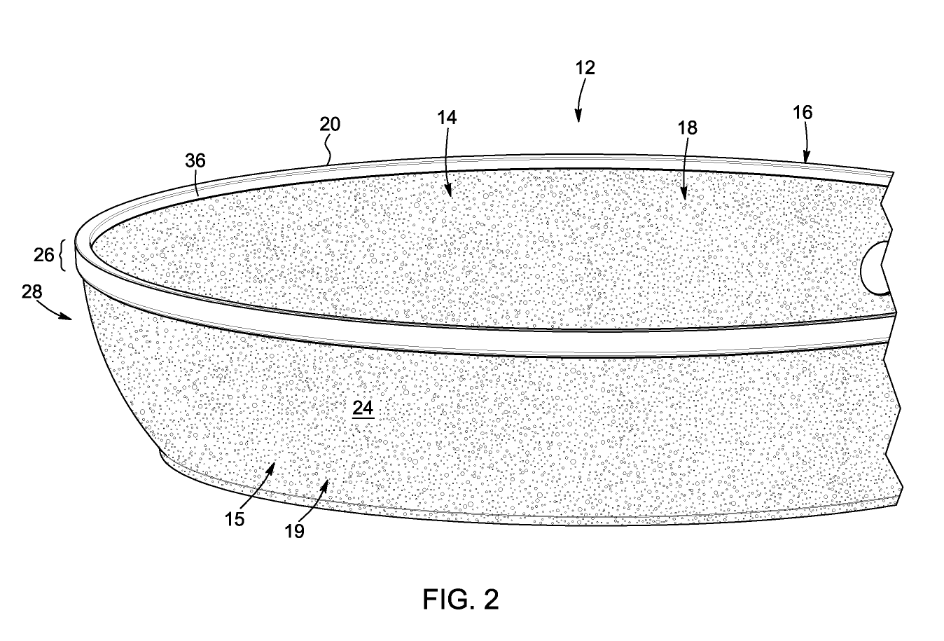

As better illustrated in FIGS. 2, 5 and 5A, the rim portion 26 has a thickness greater than a thickness of the main portion 28 of the wall 24. More particularly, the main portion 28 of the wall 24 has a thickness of about 2.37 mm, and the rim portion 26 of the wall has a thickness of about 3.54 mm. The rim portion 26 protrudes outwardly with respect to the container portion 12. The rim portion 26 comprises an interior side 32 prolonging an interior side 34 of the main portion 28 of the wall 24.

Depending on particular embodiments, the main portion 28 and/or the rim portion 26 of the wall 24 may have a thickness ranging between about 0.5 mm and about 10 mm (preferably between about 1.5 mm and about 3 mm).

It is to be understood also, that in accordance with alternate embodiments, the rim portion substantially prolongs the main portion of the wall of the container portion, such that the rim portion has a substantially similar thickness as the main portion of the wall. Alternatively, the wall may gradually increase in thickness toward the edge of the container portion. Various other alternative embodiments may be considered. Indeed and for example, the wall may have varying thicknesses at different areas of the wall.

Referring back to the drawings, namely FIGS. 2, 5 and 5A, the protective rim component 20 is mounted onto the rim portion 26 of the container portion 12, so as to substantially cover the rim portion 26 of the container portion 12. The protective rim component 20 comprises a sheet material 36 mounted onto said rim portion 26 of the container portion 12. The sheet material 36 has a thickness of about 0.25 mm. The sheet material 36 extends across the edge 16 of the container portion 12, along the interior side 14 of the container portion 12 by about 3 mm from the edge 16, and along the exterior side 15 of the container portion 12 by about 7.32 mm from the edge 16. As can be seen, the sheet material 36 extends inwardly along a recessed portion 38 of the rim portion 26. The sheet material 36 is thus clamped about the rim portion 26. The sheet material 36 thus includes an edge portion 36′, an interior portion 36″ and an exterior portion 36′″.

Depending on particular embodiments, the protective rim component 20 may have a thickness ranging between about 0.1 mm and about 3 mm. The sheet material may extend along the interior side of the container portion by a length ranging up to about 5 cm (preferably between about 1 mm and about 1.5 cm) depending on the particular embodiment. The sheet material may extend along the exterior side of the container portion by a length ranging up to about 5 cm (preferably between about 1 mm and about 1.5 cm) depending on the particular embodiment.

As previously mentioned, the container portion 12 according to the embodiment described with reference to the figures, comprises aluminum while the protective rim component 20 comprises stainless steel. The container portion 12 is made as an integral component, and the protective rim component 20 is made as a distinct integral component.

The non-stick surface 18 of the interior side 14 of the container portion 12 has been surface treated with a metal pellet treatment where metal pellets are shot at high speed against the surface to form dimples across the treated surface, in order to produce said non-stick interior cooking surface 18. The non-stick surface 18 of the interior side 14 further comprises a non-stick coating. The exterior side 15 of the container portion 12 also comprises a non-stick surface 19. Similarly to the interior non-stick surface 18, the exterior side 15 has been surface treated with a metal pellet treatment where metal pellets are shot at high speed against the surface to form dimples across the treated surface, in order to produce said non-stick surface 19 which further comprises a non-stick coating. As can be seen in the drawings, the non-stick surface 18, 19 extends across the entire surface on the interior side 14 and across the exterior side 15 of the wall 24.

The metal pellet treatment involves subjecting the cooking vessel to high strength alloy steel balls (having about 2 mm in diameter) to impact the surface densely (about 200 particles/cm³) and uniformly at high speed (with a final velocity of 21 m/sec, providing an impact load of 0.92 N or 1.3 PSI) and kinetic energy to produce a homogeneous passivation layer having depressions shaped substantially semi-spherically, resembling meteorite craters. The depressions are distributed substantially homogeneously and densely across the treated surface of the blank forming a concavely and convexed grooved (or “dimpled”) surface.

The depressions on the dimpled surface have an average depth of 0.2 to 0.3 mm and an average diameter ranging between 1 to 1.5 mm. The dimpled surface is then sand-blasted using 40# to 65# high quality corundum to produce a microcosmic level rough surface of 2 to 4 μm in depth, on the dimpled surface. This roughened surface ensures a better adhesion of the non-stick coating applied thereafter.

It is to be understood that in accordance with alternate embodiments, any of the non-stick surfaces may be obtained from or in combination with any other suitable method for producing a non-stick surface. Indeed, any suitable process for producing a textured surface enhancing non-stick properties may be considered, in accordance with alternative embodiments. In addition, the non-stick surface may or may not include a non-stick coating.

After the container portion has been made with said non-stick surface, the protective rim component is mounted thereon.

The above-mentioned cooking vessel may be provided in a variety of embodiments. For example, the protective rim component may be shaped and configured to abut, at least partially, against an upper edge of the container portion. In such an embodiment, the protective rim component may have a thickness greater than the thickness of the edge of the container portion. As another example, the cooking vessel may have any suitable shape of container portion, and corresponding protective rim component.

Although the embodiment described herein refer to a pan, it will be appreciated that embodiments of the present invention may also be adapted for a baking dish, a plate and/or the like, as can also be easily understood by a person skilled in the art, without departing from the scope of the present invention.

The above-described embodiments are considered in all respect only as illustrative and not restrictive, and the present application is intended to cover any adaptations or variations thereof, as apparent to a person skilled in the art. Of course, numerous modifications could be made to the above-described embodiments without departing from the scope of the invention, as apparent to a person skilled in the art.

1. A cooking vessel comprising:
a container portion having an interior side and an edge delimiting the container portion, said interior side comprising a non-stick cooking surface; and
a protective rim component mounted along the edge of the container portion, in order to shield the edge of the container portion.

2. A cooking vessel according to claim 1, wherein the non-stick interior cooking surface extends substantially along the interior side of the container portion.

3. A cooking vessel according to claim 1, wherein the container portion comprises a wall extending from the edge, the wall comprising a rim portion extending along said edge of the container portion and a main portion extending from the rim portion.

4. A cooking vessel according to claim 3, wherein the rim portion has a thickness greater than a thickness of the main portion of the wall.

5. A cooking vessel according to claim 4, wherein the rim portion protrudes outwardly with respect to the container portion.

6. A cooking vessel according to claim 3, wherein the rim portion comprises an interior side prolonging an interior side of the main portion of the wall.

7. A cooking vessel according to claim 3, wherein the protective rim component is mounted onto the rim portion of the container portion.

8. A cooking vessel according to claim 3, wherein the protective rim component substantially covers the rim portion of the container portion.

9. A cooking vessel according to claim 3, wherein the protective rim component comprises a sheet material mounted onto said rim portion of the container portion.

10. A cooking vessel according to claim 9, wherein the sheet material is clamped about said rim portion.

11. A cooking vessel according to claim 1, wherein the protective rim component extends along a substantially portion of the edge of the container portion.

12. A cooking vessel according to claim 1, wherein the rim component extends substantially across the edge of the container portion.

13. A cooking vessel according to claim 1, wherein the rim component extends along said interior side of the container portion.

14. A cooking vessel according to claim 1, wherein the container portion comprises an exterior side opposite the interior side, and wherein the rim component extends along said exterior side of the container portion.

15. A cooking vessel according to claim 1, wherein the container portion comprises an exterior side opposite the interior side, the exterior side comprising a non-stick surface.

16. A cooking vessel according to claim 15, wherein the non-stick surface of the exterior side has been surface treated with a metal pellet treatment where metal pellets are shot at high speed against the surface to form dimples across the treated surface, in order to produce said non-stick surface.

17. A cooking vessel according to claim 15, wherein the non-stick surface of the exterior side comprises a non-stick coating.

18. A cooking vessel according to claim 1, wherein the non-stick surface of the interior side of the container portion has been surface treated with a metal pellet treatment where metal pellets are shot at high speed against the surface to form dimples across the treated surface, in order to produce said non-stick interior cooking surface.

19. A cooking vessel according to claim 18, wherein the non-stick surface of the interior side comprises a non-stick coating.

20. A cooking vessel according to claim 1, wherein the container portion comprises aluminum.

21. A cooking vessel according to claim 1, wherein the protective rim component comprises stainless steel.

22. A cooking vessel according to claim 1, wherein the protective rim component has a composition of greater resistance than a composition of said container portion.

23. A cooking vessel according to claim 1, wherein the container portion comprises an undersurface for contacting a heating element, the undersurface comprising a peripheral ring having been machined from the container portion for protecting said undersurface.

24. A method of manufacturing a cooking vessel comprising:
providing a container portion having an interior side and an edge delimiting the container portion;
treating said interior side for producing a non-stick cooking surface; and
mounting a protective rim component along the edge of the container portion, in order to shield the edge of the container portion.
